(19) United States
(12) Patent Application Publication
(10) Pub. No.: US 2022/0276341 A1
(43) Pub. Date: Sep. 1, 2022

(54) MEASUREMENT DEVICE, MEASUREMENT METHOD, AND PROGRAM

(71) Applicant: SONY SEMICONDUCTOR SOLUTIONS CORPORATION, KANAGAWA (JP)

(72) Inventors: KAZUKI AKUTAGAWA, KANAGAWA (JP); YASUNORI TSUKUDA, KUMAMOTO (JP); HIROYUKI HIRANO, TOKYO (JP); NOBORU SAKIMURA, KANAGAWA (JP); TATSUO KUROIWA, KANAGAWA (JP)

(21) Appl. No.: 17/597,406

(22) PCT Filed: Jul. 2, 2020
(86) PCT No.: PCT/JP2020/025982

§ 371 Date: Jan. 5, 2022

(30) Foreign Application Priority Data
Jul. 16, 2019 (JP) 2019-130868
Apr. 17, 2020 (JP) 2020-074371

(51) Int. Cl. G01S 7/484; G01S 7/4865; G01S 17/10

(52) U.S. Cl. CPC G01S 7/484; G01S 7/4865; G01S 17/10

(57) ABSTRACT

The present disclosure relates to a measurement device, a measurement method, and a program that enable measurement of a distance with high accuracy in a shorter time.

A signal for giving an instruction on emission timing to emit a pulse of laser light is generated repeatedly for each predetermined processing cycle, and a count code indicating timing at which a pulse of reflected light that is the laser light reflected by a distance measurement target and returned is received is continuously counted at the time of switching a processing cycle. Then, an instruction on an emission delay value indicating a time for delaying the emission timing from the start of the processing cycle is given to be different for each processing cycle. The present disclosure can be applied to a measurement device that measures a distance.

### TECHNICAL FIELD

The present disclosure relates to a measurement device, a measurement method, and a program, and more particularly to a measurement device, a measurement method, and a program capable of measuring a distance with high accuracy in a shorter time.

### BACKGROUND ART

Conventionally, in time of flight (TOF), which is a technique for measuring a distance using a flight time of light, a time from when pulsed laser light is output toward a distance measurement target until a pulse of reflected light, which is laser light reflected by the distance measurement target and returned, is received is measured. Then, a processing cycle of outputting the pulsed laser light is repeated, a histogram of measurement values measured in a plurality of the processing cycles is generated, and the distance to the distance measurement target is calculated on the basis of the measurement value indicating a peak of the histogram.

For example, Patent Document 1 discloses an optical distance measurement device that combines a plurality of light receiving signals output from a plurality of light receiving pixels to improve detection performance for an object to be measured located far away or an object to be measured with low reflectance.

### CITATION LIST

### Patent Document

Patent Document 1: Japanese Patent Application Laid-Open No. 2016-176750

### SUMMARY OF THE INVENTION

### Problems to be Solved by the Invention

By the way, in the conventional TOF, in a case of emitting a pulse of laser light at the same emission timing (for example, the same timing as the start of each processing cycle, timing when the same fixed time has elapsed from the start of each processing cycle, or the like) in each processing cycle, a time required for measurement becomes long, for example, there are some cases where a time required for measurement becomes long or differential non-linearity (DNL) directly affects distance measurement accuracy.

The present disclosure has been made in view of such a situation, and an object of the present disclosure is to enable measurement of a distance with high accuracy in a shorter time.

### Solutions to Problems

A measurement device according to one aspect of the present disclosure includes an emission timing signal generation unit configured to generate a signal for giving an instruction on emission timing to emit a pulse of laser light repeatedly for each predetermined processing cycle; a counter configured to continuously count a count code at a time of switching the processing cycle, the count code indicating timing at which a pulse of reflected light that is the laser light reflected by a distance measurement target and returned is received; and a timing instruction unit configured to make an emission delay value different for the each processing cycle, the emission delay value indicating a time for delaying the emission timing from start of the processing cycle, and instruct the emission timing signal generation unit on the emission delay value.

A measurement method or a program according to one aspect of the present disclosure includes generating a signal for giving an instruction on emission timing to emit a pulse of laser light repeatedly for each predetermined processing cycle; continuously counting a count code at a time of switching the processing cycle, the count code indicating timing at which a pulse of reflected light that is the laser light reflected by a distance measurement target and returned is received; and making an emission delay value different for the each processing cycle, the emission delay value indicating a time for delaying the emission timing from start of the processing cycle, and giving an instruction on the emission delay value.

In one aspect of the present disclosure, a signal for giving an instruction on emission timing to emit a pulse of laser light is generated repeatedly for each predetermined processing cycle; a count code is continuously counted at a time of switching the processing cycle, the count code indicating timing at which a pulse of reflected light that is the laser light reflected by a distance measurement target and returned is received; and an emission delay value is made different for the each processing cycle, the emission delay value indicating a time for delaying the emission timing from start of the processing cycle, and an instruction on the emission delay value is given.

### BRIEF DESCRIPTION OF DRAWINGS

FIG. 1 is a block diagram illustrating a configuration example of an embodiment of a measurement device to which the present technology is applied.

FIG. 2 is a diagram for describing a processing cycle and pulse emission timing.

FIG. 3 is a flowchart for describing a processing example of distance measurement processing.

FIG. 4 is a diagram for describing an effect of suppressing occurrence of a ghost caused by a pulse of reflected light detected outside a distance measurement range time.

FIG. 5 is a diagram for describing an effect of performing distance measurement processing using laser light having the number of pulse emissions of two or more times within one processing cycle.

FIG. 6 is a diagram for describing an effect obtained by canceling an influence of DNL on measurement accuracy.

FIG. 7 is a diagram for describing an effect of canceling an influence of DNL on measurement accuracy in a configuration of separating an upper bit and lower bits.

FIG. 8 is a diagram for describing an influence of noise due to disturbance radio waves synchronized with a processing cycle.

FIG. 9 is a diagram for describing an effect of suppressing an influence of noise due to disturbance radio waves synchronized with a processing cycle.

FIG. 10 is a diagram for describing a case where the pulse emission timing is not changed over the entire processing cycle.

FIG. 11 is a diagram for describing an effect obtained by changing a maximum value of a count code.

FIG. 12 is a diagram for describing an effect of shifting a distance measurement range time.

FIG. 13 is a diagram illustrating a modification of a ramp waveform.

FIG. 14 is a diagram for describing a processing example in which an emission delay value is shifted at equal intervals for each processing cycle.

FIG. 15 is a diagram for describing a method for controlling laser irradiation timing and a method for processing a TOF result.

FIG. 16 is a flowchart for describing processing in which an emission delay value is shifted in a predetermined pattern for each processing cycle.

FIG. 17 is a diagram for describing an effect obtained by canceling an influence of DNL on measurement accuracy in a case where an emission delay value is shifted in a predetermined pattern for each processing cycle.

FIG. 18 is a diagram illustrating a first example for describing a shape of a ghost histogram due to an influence of out-of-range ToF.

FIG. 19 is a diagram illustrating a second example for describing a shape of a ghost histogram due to an influence of out-of-range ToF.

FIG. 20 is a block diagram illustrating a configuration example of an embodiment of a computer to which the present technology is applied.

### MODE FOR CARRYING OUT THE INVENTION

Hereinafter, specific embodiments to which the present technology is applied will be described in detail with reference to the drawings.

<Configuration Example of Measurement Device>

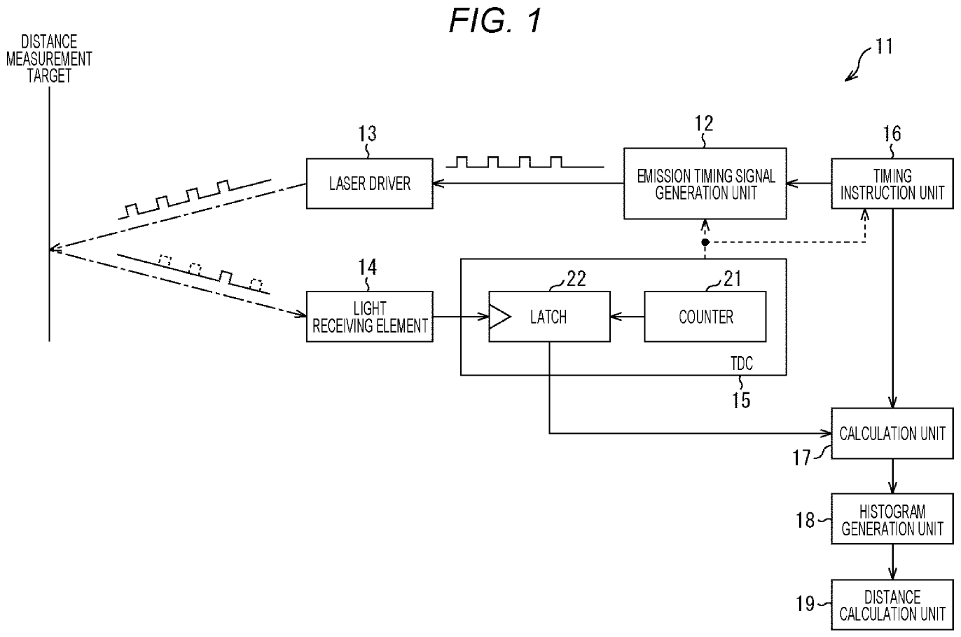

FIG. 1 is a block diagram illustrating a configuration example of an embodiment of a measurement device to which the present technology is applied.

For example, a measurement device 11 illustrated in FIG. 1 measures a distance to a distance measurement target by measuring a time from when pulsed laser light is output toward the distance measurement target until a pulse of reflected light, which is laser light reflected by the distance measurement target and returned, is received. Note that FIG. 1 illustrates that, even if four pulses of laser light is output toward the distance measurement target, in a case where the distance to the distance measurement target is long, three pulses indicated by the broken line do not return and one pulse returns as the reflected light.

As illustrated in FIG. 1, the measurement device 11 includes an emission timing signal generation unit 12, a laser driver 13, a light receiving element 14, a TDC 15, a timing instruction unit 16, a calculation unit 17, a histogram generation unit 18, and a distance calculation unit 19. Furthermore, the TDC 15 includes a counter 21 and a latch 22. For example, in the measurement device 11, in a case where the blocks are completely synchronized with one another, a processing cycle can be started in synchronization with the blocks. Alternatively, in the measurement device 11, in a case where the blocks are not completely synchronized with one another, a signal for notifying the start of the processing cycle is supplied from the TDC 15 to the emission timing signal generation unit 12 and the timing instruction unit 16 as indicated by the broken arrows.

The emission timing signal generation unit 12 generates a Tx pulse signal for giving an instruction on emission timing to emit a pulse by laser light output from the measurement device 11, and supplies the Tx pulse signal to the laser driver 13. At this time, the emission timing signal generation unit 12 can delay emission timing from timing of starting the processing cycle according to an emission delay value supplied from the timing instruction unit 16.

The laser driver 13 drives a laser light emitting element (not illustrated) according to the Tx pulse signal supplied from the emission timing signal generation unit 12, and outputs the pulsed laser light on the basis of the emission timing.

The light receiving element 14 is, for example, a single photon avalanche diode (SPAD), receives reflected light of the pulsed laser light reflected by the distance measurement target and returned, and supplies an Rx pulse signal indicating a waveform of the reflected light to the latch 22 of the TDC 15.

The time-to-digital conversion (TDC) 15 converts the time until the laser light output from the measurement device 11 is reflected by the distance measurement target and returned into a digital value. That is, the counter 21 starts counting up of a count code in accordance with the start of the processing cycle, and the latch 22 fetches the count code from the counter 21 at timing of the pulse indicated by the Rx pulse signal supplied from the light receiving element 14 and outputs the count code.

The timing instruction unit 16 supplies the emission delay value indicating a time for delaying the emission timing of the pulse from the start of the processing cycle to the emission timing signal generation unit 12 and the calculation unit 17 to given an instruction on the emission timing for emitting the pulse from the measurement device 11. Then, the timing instruction unit 16 can change the emission delay value for each processing cycle. As a result, the measurement device 11 emits the pulse at different emission timing from the start of the processing cycle for each processing cycle.

Here, in the present embodiment, changing the emission timing for emitting the pulse for each processing cycle according to the emission delay value an instruction on which is given by the timing instruction unit 16 will be hereinafter referred to as pulse modulation.

The calculation unit 17 performs calculation of subtracting the emission delay value supplied from the timing instruction unit 16 from the count code supplied from the latch 22 of the TDC 15, and supplies a value calculated by the calculation to the histogram generation unit 18 as a ToF value. That is, in the measurement device 11, the pulsed laser light is output so that the pulse is emitted at the emission timing delayed according to the emission delay value from the start of the processing cycle. Therefore, the calculation unit 17 subtracts the emission delay value from the count code indicating the timing at which the light receiving element 14 receives the pulse of the reflected light, thereby obtaining the ToF value corresponding to the flight time in which the laser light reciprocates between the measurement device 11 and the distance measurement target.

The histogram generation unit 18 generates a histogram of the ToF values calculated by the calculation unit 17. For example, in the measurement device 11, a plurality of processing cycles is repeatedly performed, and the histogram generation unit 18 generates a histogram using a plurality of ToF values obtained through the repetition of the processing cycles. Then, when a histogram in which one certain ToF value indicating a peak is specified is generated, the histogram generation unit 18 supplies the ToF value indicating the peak to the distance calculation unit 19.

The distance calculation unit 19 calculates the distance to the distance measurement target on the basis of the speed of light using the ToF value supplied from the histogram generation unit 18.

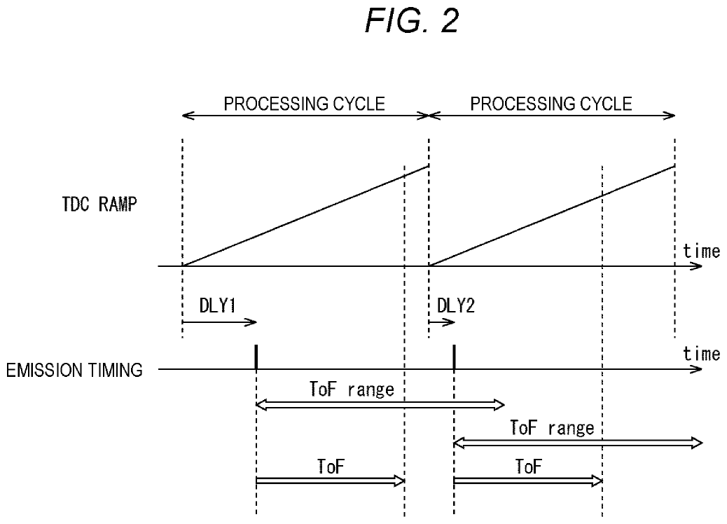

Here, the processing cycle and the pulse emission timing in the measurement device 11 will be described with reference to FIG. 2.

TDC RAMP illustrated in FIG. 2 represents a ramp waveform that visualizes the count code counted by the counter 21 of the TDC 15, and the counter 21 repeatedly performs counting up from count code 0 in each processing cycle. Then, in the measurement device 11, as indicated by the TDC RAMP, the counter 21 starts counting up without delay from the timing at which the processing cycle starts (with 0 latency).

Therefore, in the measurement device 11, the TDC RAMP does not stop at the time of switching the processing cycle, the counting by the counter 21 is continuously performed, and the counting does not stop although the count code is rese to 0. As a result, in the measurement device 11, a distance measurement range time (ToF range) started at the timing when the pulse is output in a certain processing cycle can be overlapped with the next processing cycle. Note that a distance measurement range represents a fixed distance width including a distance to the distance measurement target when the distance to the distance measurement target is a target for distance measurement, and a width of flight time in which light reciprocates between the measurement device and the distance measurement range is hereinafter referred to as a distance measurement range time.

Furthermore, in the measurement device 11, the pulse is not emitted at the timing of starting the processing cycle, but the pulse is emitted at the emission timing delayed from the start of the processing cycle according to an emission delay value DLY. Therefore, in the measurement device 11, the calculation unit 17 can obtain the ToF value corresponding to the time during which the light reciprocates in the distance to the distance measurement target by calculation of subtracting the emission delay value DLY from the count code at the timing when the pulse of reflected light is detected.

Moreover, in the measurement device 11, the timing instruction unit 16 supplies the emission delay value DLY different for each processing cycle to the emission timing signal generation unit 12 by performing the pulse modulation as described above. That is, as illustrated in FIG. 2, an emission delay value DLY1 and an emission delay value DLY2 are different from each other, and the interval from the start of the processing cycle to the emission of the pulse is adjusted so as not to be constant for each processing cycle.

In the measurement device 11 configured as described above, the counting by the counter 21 is continuously performed at the time of switching the processing cycle, and the emission timing for emitting the pulse can be made different for each processing cycle according to the emission delay value. As a result, the measurement device 11 can disperse the influence of a ghost (erroneous distance measurement) that occurs when the distance measurement range times are overlapped, as will be described below. Therefore, the measurement device 11 can measure the distance to the distance measurement target in a shorter time than a conventional configuration in which the distance measurement range time cannot be overlapped and an overhead time for pulse modulation is provided, for example.

<Processing Example of Distance Measurement Processing>

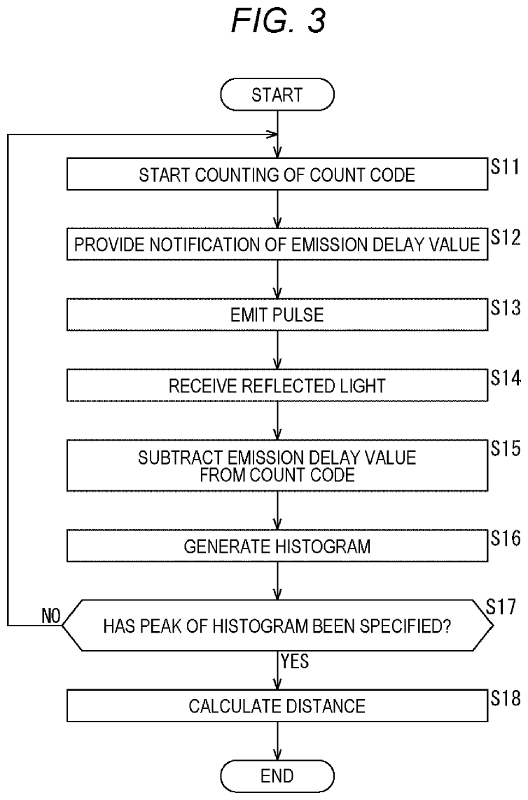

The distance measurement processing executed in the measurement device 11 will be described with reference to the flowchart illustrated in FIG. 3.

For example, when control is performed to start the distance measurement processing, the first processing cycle is started, and in step S11, the counter 21 starts counting up of the count code.

In step S12, the timing instruction unit 16 supplies the emission delay value indicating the time for delaying the emission timing of the pulse from the start of the processing cycle to the emission timing signal generation unit 12 and the calculation unit 17.

In step S13, the emission timing signal generation unit 12 supplies, to the laser driver 13, the Tx pulse signal for giving an instruction on emission of the pulse at the emission timing delayed from the start of the processing cycle according to the emission delay value supplied from the timing instruction unit 16 in step S12. As a result, the laser driver 13 drives a laser light emitting element (not illustrated) to output pulsed laser light that emits the pulse in accordance with the emission timing indicated by the Tx pulse signal.

In step S14, the light receiving element 14 receives the reflected light of the pulsed laser light output in step S13, and supplies the Rx pulse signal indicating the waveform of the reflected light to the latch 22. As a result, the latch 22 fetches the count code from the counter 21 at the timing of the pulse indicated by the Rx pulse signal supplied from the light receiving element 14, and supplies the count code to the calculation unit 17.

In step S15, the calculation unit 17 obtains the ToF value by performing calculation of subtracting the emission delay value supplied from the timing instruction unit 16 in step S12 from the count code supplied from the latch 22 in step S14, and supplies the ToF value to the histogram generation unit 18.

In step S16, the histogram generation unit 18 generates the histogram using the plurality of ToF values supplied from the calculation unit 17 in step S15 repeatedly performed.

In step S17, the histogram generation unit 18 determines whether or not a peak of the ToF value has been specified in the histogram generated in the previous step S16, for example, whether or not a histogram showing a peak in a predetermined ToF value has been generated.

In step S17, in a case where the histogram generation unit 18 determines that the peak of the ToF value has not been specified in the histogram generated in the previous step S16, the processing returns to step S11. At this time, the counter 21 performs counting up up to the maximum value of the count code and resets the count code to 0 at the timing of the next count, and the second and subsequent processing cycles are repeatedly performed in a similar manner.

Meanwhile, in step S17, in a case where the histogram generation unit 18 determines that the peak of the ToF value has been specified in the histogram generated in the previous step S16, the processing proceeds to step S18. That is, the processing cycle is repeated until a histogram indicating a peak at a predetermined ToF value is generated.

In step S18, the histogram generation unit 18 supplies the ToF value specified as a peak in the histogram to the distance calculation unit 19. Then, after the distance calculation unit 19 calculates the distance to the distance measurement target using the ToF value, the processing is terminated.

By the measurement processing as described above, the measurement device 11 can measure the distance to the distance measurement target with high accuracy in a shorter time.

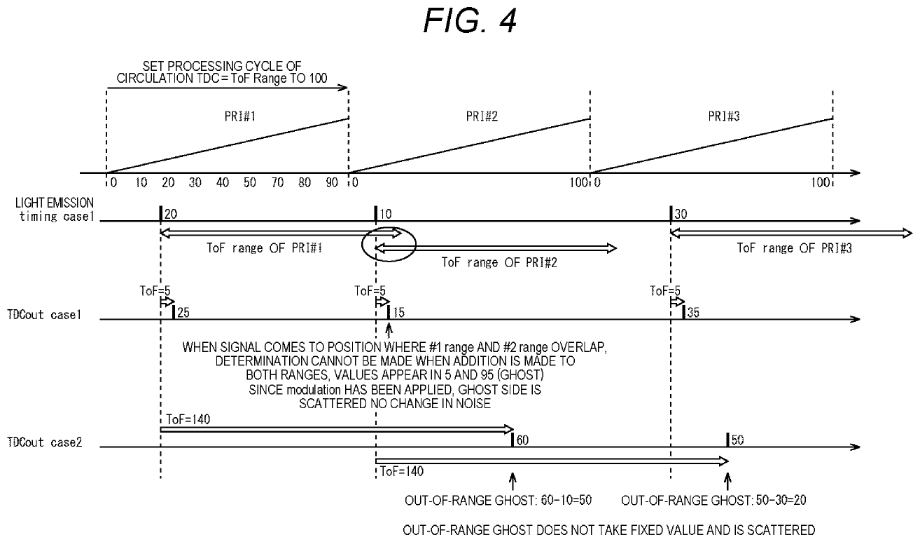

For example, by performing pulse modulation, the measurement device 11 can suppress an adverse effect caused by obtaining a ToF value (hereinafter referred to as a ghost ToF value) different from a true ToF value according to the distance to the distance measurement target, as will be described below with reference to FIG. 4. As a result, the time required for measuring the distance to the distance measurement target can be shortened.

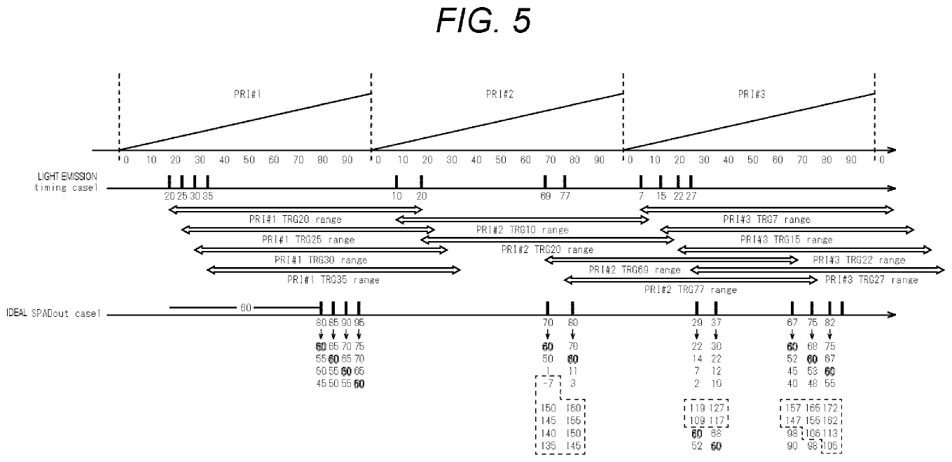

Furthermore, the measurement device 11 can set the distance measurement range time in an overlapping manner by continuously performing the counting by the counter 21 at the time of switching the processing cycle, and can perform the distance measurement processing using the laser light having the number of pulse emissions of two or more times within one processing cycle, as will be described below with reference to FIG. 5. As a result, more ToF values can be obtained in a short time, and a peak in a histogram can be specified more quickly.

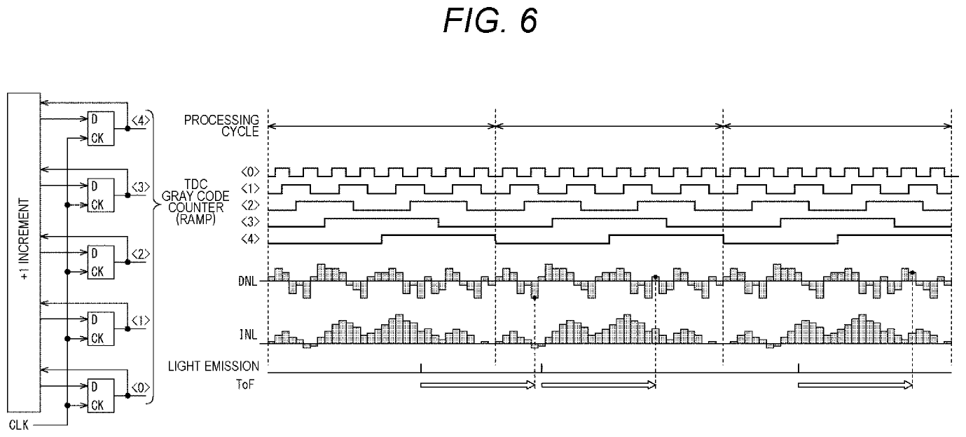

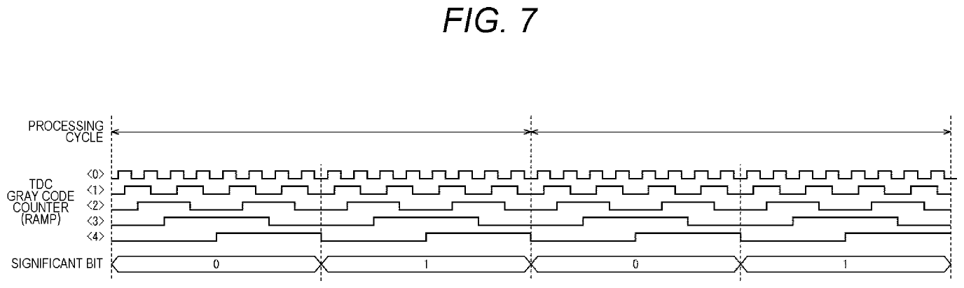

Furthermore, by performing pulse modulation, the measurement device 11 cancels the influence of DNL on the measurement accuracy, and can further improve the measurement accuracy, as will be described below with reference to FIGS. 6 and 7.

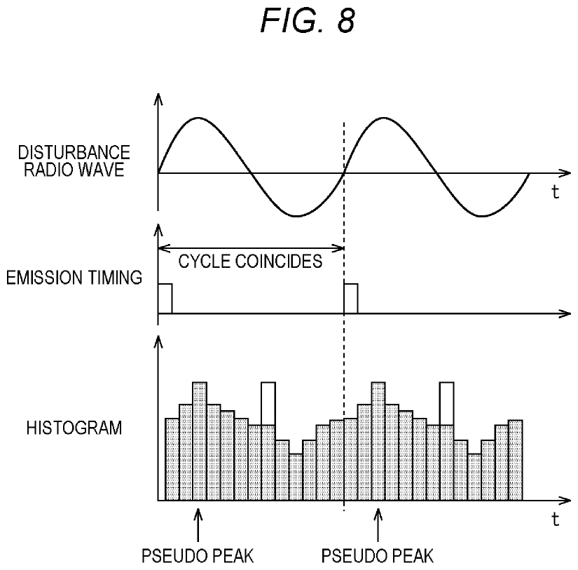

Furthermore, by performing pulse modulation, the measurement device 11 can suppress the influence of noise due to disturbance radio waves synchronized with the processing cycle, and can further improve measurement accuracy, as will be described below with reference to FIGS. 8 to 11.

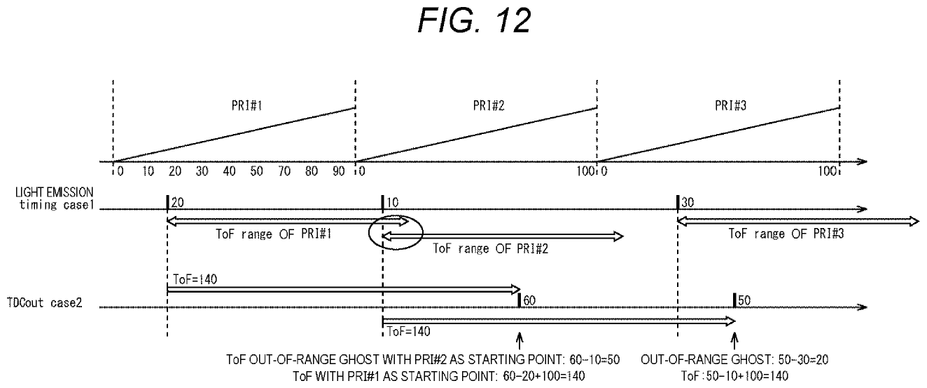

Furthermore, the measurement device 11 can set the distance measurement range time across the processing cycles by continuously performing the counting by the counter 21 at the time of switching the processing cycle, and can shift the distance measurement range time, as will be described below with reference to FIG. 12.

<Effect of Distance Measurement Processing>

Effects obtained by the distance measurement processing of the measurement device 11 as described above will be described with reference to FIGS. 4 to 12.

FIG. 4 is a diagram for describing an effect of suppressing occurrence of the ghost ToF value caused by the pulse of reflected light detected outside the distance measurement range time in the measurement device 11.

FIG. 4 illustrates processing cycles #1 to #3 repeated in a cyclic manner. Then, counting up by the counter 21 is started from the timing when each processing cycle starts, and the count codes 0 to 100 are counted in one processing cycle. Furthermore, the distance measurement range time is set so as to coincide with the time corresponding to one processing cycle, that is, so as to coincide with the time required to count the count code 100 by the counter 21.

Then, as described above, the measurement device 11 is configured to perform the pulse modulation in which the emission timing for emitting the pulse is changed for each processing cycle according to the emission delay value. Therefore, in the example illustrated in FIG. 4, the pulse is emitted with the emission delay value 20 from the start of the processing cycle in the processing cycle #1, the pulse is emitted with the emission delay value 10 from the start of the processing cycle in the processing cycle #2, and the pulse is emitted with the emission delay value 30 from the start of the processing cycle in the processing cycle #3.

Thereby, the distance measurement range time corresponding to the pulse emitted with the emission delay value 20 in the processing cycle #1 is from the count code 20 in the processing cycle #1 to the count code 20 in the processing cycle #2. Furthermore, the distance measurement range time corresponding to the pulse emitted with the emission delay value 10 in the processing cycle #2 is from the count code 10 in the processing cycle #2 to the count code 10 in the processing cycle #3. At this time, the distance measurement range time corresponding to the pulse emitted with the emission delay value 20 in the processing cycle #1 and the distance measurement range time corresponding to the pulse emitted with the emission delay value 10 in the processing cycle #2 overlap between the count code 10 and the count code 20 in the processing cycle #2.

First, case 1 (TDCout case1) of the count code output from the TDC 15 illustrated in FIG. 4 will be described. For example, in case 1, the count code 25 is output in the processing cycle #1, the count code 15 is output in the processing cycle #2, and the count code 35 is output in the processing cycle #3.

Therefore, in a case where the reflected light detected at the count code 25 in the processing cycle #1 is the reflected light of the pulse emitted with the emission delay value 20 in the processing cycle #1, the ToF value 5 is obtained by subtracting the emission delay value 20 from the count code 25. Similarly, in a case where the reflected light detected at the count code 15 in the processing cycle #2 is the reflected light of the pulse emitted with the emission delay value 10 in the processing cycle #2, the ToF value 5 is obtained by subtracting the emission delay value 10 from the count code 15. Moreover, in a case where the reflected light detected at the count code 35 in the processing cycle #3 is the reflected light of the pulse emitted with the emission delay value 30 in the processing cycle #3, the ToF value 5 is obtained by subtracting the emission delay value 30 from the count code 35.

Thereafter, when a similar processing cycle is repeatedly performed and a histogram of ToF values obtained in these processing cycles is generated, the ToF value 5 shows a peak.

By the way, the reflected light detected at the count code 15 in the processing cycle #2 is in a range in which the distance measurement range time corresponding to the pulse emitted with the emission delay value 20 in the processing cycle #1 and the distance measurement range time corresponding to the pulse emitted with the emission delay value 10 in the processing cycle #2 overlap with each other. Therefore, it is not possible to determine which distance measurement range time is to be applied.

For example, in a case where the distance measurement range time for the pulse emitted with the emission delay value 20 in the processing cycle #1 is applied, the count code 15 in the processing cycle #2 corresponds to the count code 115 when counting is continued from the start of the processing cycle #1, and the ToF value 95 is obtained by subtracting the emission delay value 20 in the processing cycle #1.

However, in the measurement device 11, since the pulse modulation as described above is performed, the ghost ToF value 95 does not indicate a fixed value unlike the true ToF value 5, and is scattered and dispersed in response to changing the emission delay value for each processing cycle. Note that, at this time, there is no change in noise.

As described above, in the measurement device 11, since the ghost ToF value is scattered, an adverse effect caused by obtaining the ghost ToF value can be suppressed, and a histogram in which the true ToF value shows a peak can be generated in a shorter time. Therefore, the measurement device 11 can shorten the time required for measuring the distance to the distance measurement target.

Furthermore, case 2 (TDCout case2) of the count code output from the TDC 15 illustrated in FIG. 4 will be described. For example, in case 2, the count code is not output in the processing cycle #1, the count code 60 is output in the processing cycle #2, and the count code 50 is output in the processing cycle #3.

Therefore, in a case where the reflected light detected at the count code 60 of the processing cycle #2 is the reflected light of the pulse emitted with the emission delay value 20 of the processing cycle #1, the ToF value 140 is obtained by subtracting the emission delay value 20 from the count code 60 (the count code 160 from the start of the processing cycle #1) of the processing cycle #2. Similarly, in a case where the reflected light detected at the count code 50 of the processing cycle #3 is the reflected light of the pulse emitted with the emission delay value 10 of the processing cycle #2, the ToF value 140 is obtained by subtracting the emission delay value 10 from the count code 50 (the count code 150 from the start of the processing cycle #2) of the processing cycle #3.

Thereafter, when a similar processing cycle is repeatedly performed and a histogram of ToF values obtained in these processing cycles is generated, the ToF value 140 shows a peak.

By the way, in a case where the reflected light detected at the count code 60 of the processing cycle #2 is the reflected light of the pulse emitted with the emission delay value 10 of the processing cycle #2, the ToF value 50 is obtained by subtracting the emission delay value 10 from the count code 60 of the processing cycle #2. Similarly, in a case where the reflected light detected at the count code 50 of the processing cycle #3 is the reflected light of the pulse emitted with the emission delay value 30 of the processing cycle #3, the ToF value 20 is obtained by subtracting the emission delay value 30 from the count code 50 of the processing cycle #3. However, the ToF value 50 and the ToF value 20 are scattered as the pulse modulation as described above is performed and the emission delay value is changed for each processing cycle, and do not have a fixed ToF value. That is, the ToF value 50 and the ToF value 20 can be determined to be ghost ToF values.

As described above, in the measurement device 11, since the ghost ToF value is scattered, an adverse effect caused by obtaining the ghost ToF value can be suppressed, and a histogram in which the true ToF value shows a peak can be generated in a shorter time. Therefore, the measurement device 11 can shorten the time required for measuring the distance to the distance measurement target.

Furthermore, the measurement device 11 can set the distance measurement range time to coincide with the time corresponding to one processing cycle, and can perform the distance measurement in a shorter time than, for example, a configuration in which the time corresponding to one processing cycle needs to be set longer than the distance measurement range time (for example, an overhead time is provided.).

Furthermore, an effect of performing the distance measurement processing using the laser light having the number of pulse emissions of two or more times within one processing cycle in the measurement device 11 will be described with reference to FIG. 5.

For example, usually, the laser light having the number of pulse emissions of one is output within one processing cycle. In contrast, the measurement device 11 can set the distance measurement range time in an overlapping manner, and can output the laser light having the number of pulse emissions of two or more times within one processing cycle.

FIG. 5 illustrates an example of the laser light having the number of pulse emissions of four times in one processing cycle. Furthermore, the distance measurement range time of a time (100 counts) corresponding to the processing cycle is set from the pulse emission timing.

Furthermore, in the example illustrated in FIG. 5, in the processing cycle #1, the first pulse is emitted with the emission delay value 20, the second pulse is emitted with the emission delay value 25, the third pulse is emitted with the emission delay value 30, and the fourth pulse is emitted with the emission delay value 35. Similarly, in the processing cycle #2, the first pulse is emitted with the emission delay value 10, the second pulse is emitted with the emission delay value 20, the third pulse is emitted with the emission delay value 69, and the fourth pulse is emitted with the emission delay value 77. Furthermore, in the processing cycle #3, the first pulse is emitted with the emission delay value 7, the second pulse is emitted with the emission delay value 15, the third pulse is emitted with the emission delay value 22, and the fourth pulse is emitted with the emission delay value 27.

Meanwhile, the pulse of the reflected light is detected at the count code 80, the count code 85, the count code 90, and the count code 95 in the processing cycle #1. Similarly, the pulse of the reflected light is detected at the count code 70 and the count code 80 in the processing cycle #2. Furthermore, the pulse of the reflected light is detected at the count code 29, the count code 37, the count code 67, the count code 75, and the count code 82 in the processing cycle #3.

Then, the measurement device 11 performs calculation, for each count code in which the pulse of the reflected light is detected, for obtaining the ToF values by subtracting the emission delay values that are timings at which a plurality of distance measurement range times including the count code is started from the count code.

For example, for the pulse of the reflected light detected at the count code 80 in the processing cycle #1, the count code 80 in the processing cycle #1 is included in the four distance measurement range times. Therefore, the ToF value 60, the ToF value 55, the ToF value 50, and the ToF value 45 are obtained by subtracting the emission delay values (20, 25, 30, and 35), which are timings at which the four distance measurement range times including the count code 80 of the processing cycle #1 are started, from the count code 80 of the processing cycle #1.

Furthermore, for the pulse of the reflected light detected at the count code 70 in the processing cycle #2, the count code 70 in the processing cycle #2 is included in the three distance measurement range times. Therefore, the ToF value 60, the ToF value 50, and the ToF value 1 are obtained by subtracting the emission delay values (10, 20, and 69), which are timings at which the three distance measurement range times including the count code 70 of the processing cycle #2 are started, from the count code 70 of the processing cycle #2.

Furthermore, for the pulse of the reflected light detected at the count code 29 in the processing cycle #3, the count code 29 in the processing cycle #3 is included in the six distance measurement range times. Therefore, the ToF value 22, the ToF value 14, the ToF value 7, the ToF value 2, the ToF value 60, and the ToF value 52 are obtained by subtracting the emission delay values (69 and 77 in the processing cycle #2 and 7, 15, 22, and 27 in the processing cycle #3), which are timings at which the six distance measurement range times including the count code 29 of the processing cycle #3 are started, from the count code 29 of the processing cycle #3 (or the count code 129 corresponding to the processing cycle #2).

Furthermore, for the pulse of the reflected light detected at the count code 75 in the processing cycle #3, the count code 75 in the processing cycle #3 is included in the five distance measurement range times. Therefore, the ToF value 68, the ToF value 60, the ToF value 53, the ToF value 48, and the ToF value 98 are obtained by subtracting the emission delay values (77 in the processing cycle #2, and 7, 15, 22, and 27 in the processing cycle #3), which are timings at which the five distance measurement range times including the count code 75 of the processing cycle #3 are started, from the count code 75 of the processing cycle #3 (or the count code 175 corresponding to the processing cycle #2).

As described above, the ToF values obtained for each count code in which the pulse of the reflected light is detected by subtracting the emission delay values that are timings at which a plurality of distance measurement range times including the count code is started from the count code include the true ToF value 60. Furthermore, the ToF values other than the true ToF value 60 are scattered and dispersed according to the change in the emission delay value for each processing cycle. Therefore, in the histogram generated from all the ToF values obtained by such an operation, the true ToF value 60 shows a peak.

Therefore, the measurement device 11 can obtain the ToF values by performing the calculation of subtracting the known emission delay values from the count code at which the respective pulses have been detected, even if the laser light having the number of pulse emissions of two or more times is output in one processing cycle. As a result, the measurement device 11 can obtain more ToF values in a short time and specify the peak in the histogram, thereby shortening the time required for the distance measurement processing.

The effect obtained by canceling the influence of DNL on the measurement accuracy in the measurement device 11 will be described with reference to FIG. 6.

FIG. 6 illustrates a configuration example of the counter 21 that includes five flip-flop circuits and outputs the count code of 32 values. Furthermore, FIG. 6 illustrates a waveform representing the count code output from the counter 21 and components of DNL and integral non-linearity (INL) for each one count. As illustrated, the components of DNL and INL have the same magnitude in the same count code for each processing cycle.

Then, as described above, in the measurement device 11, the pulse is emitted at the timing (emission ToF) delayed from the start of the processing cycle according to the emission delay value different for each processing cycle. Therefore, the timing (n FIG. 6, the timing indicated by the tip of the white arrow) at which the pulse of the reflected light is detected also differs for each processing cycle, and the count code fetched to the latch 22 at each timing also differs. As a result, since the component of DNL included in the count code for each processing cycle is also different, it is possible to cancel the influence of DNL on the distance measurement accuracy.

For example, as in the related art, in a case where the pulse is emitted at the timing at which the processing cycle starts, the timing at which the pulse of the reflected light is detected is the same regardless of the processing cycle, and the count code fetched to the latch 22 at that timing is also the same. Therefore, conventionally, the component of DNL included in the count code for each processing cycle directly affects the distance measurement accuracy.

Meanwhile, in the measurement device 11, the component of DNL included in the count code for each measurement cycle is different, and the components are averaged, so that direct influence of DNL on the measurement accuracy is canceled. Therefore, the measurement device 11 can further improve the measurement accuracy.

Moreover, as illustrated in FIG. 7, by separating an upper bit and lower bits, the influence of DNL on the measurement accuracy can be more reliably canceled.

FIG. 7 illustrates an example in which a 1-bit counter of a significant digit is provided in addition to the waveform representing the count code illustrated in FIG. 6. That is, it is possible to express a 64 value count code by adding the upper one bit to the 32 value count code (lower bits).

For example, since a transition position of the counter affects the cycle of the DNL, two cycles of the 32 value DNL cycle appear within the 64 value processing cycle by configuring this significant digit independently of the transition position. For example, the significant digits can be configured by providing redundant bits, direct counting in the latch 22, or the like.

Thus, performing the pulse modulation for 32 values within the 64 value processing cycle can achieve DNL averaging and more reliably cancels the influence of DNL on the measurement accuracy. Therefore, the measurement device 11 can further improve the measurement accuracy.

An effect of suppressing the influence of noise due to disturbance radio waves synchronized with the processing cycle will be described with reference to FIGS. 8 to 11.

For example, as illustrated in FIG. 8, in a case where the disturbance radio wave is synchronized with the processing cycle (the frequency f of the disturbance radio wave=1/the processing cycle), the count modulates the disturbance radio wave as a standing wave, and a pseudo peak may occur in the histogram due to the influence of noise by the disturbance radio wave. Therefore, in this case, when the pulse is emitted at fixed emission timing in each processing cycle without performing the pulse modulation, the pseudo peak may become higher than the peak of the count code indicating the timing at which the pulse of the reflected wave is received.

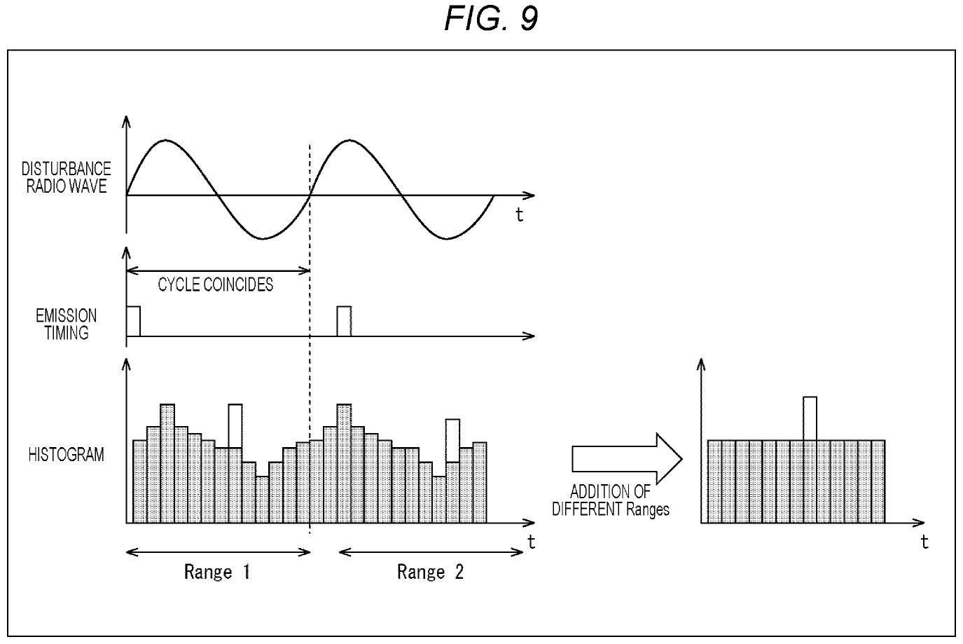

In contrast, as illustrated on the left side of FIG. 9, when the pulse is emitted at different emission timing for each processing cycle by the pulse modulation, the distance measurement range time is started at different timing according to the each emission timing. Therefore, even in a case where the disturbance radio wave is synchronized with the processing cycle, a shift occurs in the pseudo peak generated in the histogram due to the influence of noise by the disturbance radio wave for each distance measurement range time.

Therefore, it is possible to completely average the influence of the disturbance radio wave and eliminate the pseudo peak as illustrated on the right side of FIG. 9 by performing the all-area pulse modulation for changing the pulse emission timing over the entire processing cycle and adding histograms of different distance measurement range times. That is, only the count code indicating the timing at which the pulse of the reflected wave of the laser light reflected by the distance measurement target is received remains as a peak.

For example, in the measurement device 11, in a case where there is a disturbance radio wave synchronized with the processing cycle, the timing instruction unit 16 may be activated via electromagnetic induction by the disturbance radio wave, and the pulse modulation to emit the pulse at different emission timing for each processing cycle may be performed.

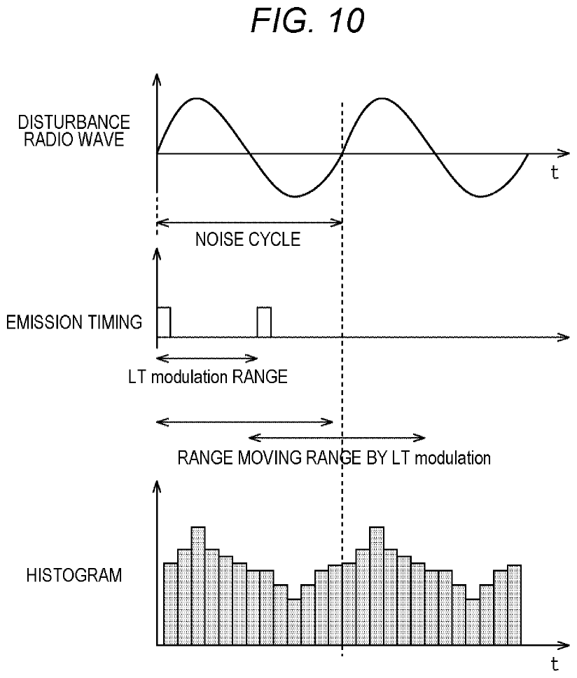

Note that, in the case that the all-area pulse modulation is not performed, the influence of the disturbance radio wave is not completely averaged. That is, as illustrated in FIG. 10, in a case where a range (modulation range of LT) in which the pulse emission timing is changed is narrower than the processing cycle without changing the pulse emission timing over the entire processing cycle, averaging is performed by integration (moving average) in a range in which the pulse emission timing is changed with each pulse as a starting point. Therefore, to completely average the influence of the disturbance radio wave and eliminate the pseudo peak, it is desirable to perform the all-area pulse modulation.

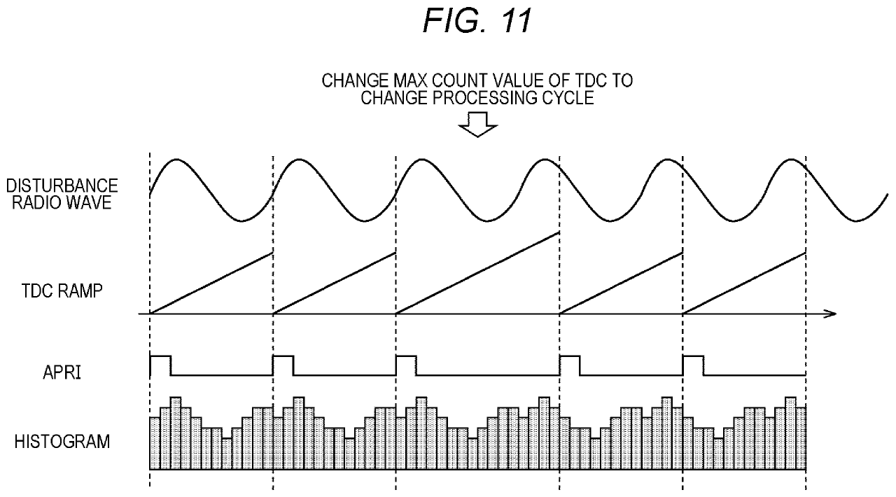

Furthermore, in a case where the all-area pulse modulation cannot be performed, as illustrated in FIG. 11, the influence of the disturbance radio wave synchronized with the processing cycle can be suppressed by changing the maximum value of the count code counted by the counter 21 in an arbitrary processing cycle. That is, the timing of the processing cycle is changed as the maximum value of the count code counted by the counter 21 is changed, and the influence of the disturbance radio wave is suppressed by shifting the phase of the processing cycle from the disturbance radio wave. Note that, in this case, the maximum value of the count code may be changed so that the processing cycle becomes long as illustrated in FIG. 11, or conversely, the maximum value of the count code may be changed so that the processing cycle becomes short.

As described above, the measurement device 11 can suppress the influence of the noise due to the disturbance radio wave synchronized with the processing cycle, and can accurately generate the histogram in which the count code indicating the timing at which the pulse of the reflected wave is received becomes the peak. As a result, the measurement device 11 can further improve the measurement accuracy.

FIG. 12 is a diagram for describing an effect of shifting the distance measurement range time depending on which emission timing is set as a starting point.

Similarly to FIG. 4, FIG. 12 illustrates the processing cycles #1 to #3 repeated in a cyclic manner. Then, the pulse is emitted with the emission delay value 20 from the start of the processing cycle in the processing cycle #1, the pulse is emitted with the emission delay value 10 from the start of the processing cycle in the processing cycle #2, and the pulse is emitted with the emission delay value 30 from the start of the processing cycle in the processing cycle #3. Furthermore, the count code is not output in the processing cycle #1, the count code 60 is output in the processing cycle #2, and the count code 50 is output in the processing cycle #3.

At this time, for the pulse of the reflected light detected at the count code 60 in the processing cycle #2, the ToF value 50 is obtained with the emission delay value 10 in the processing cycle #2 as a starting point. Furthermore, for the pulse of the reflected light detected at the count code 50 in the processing cycle #3, the ToF value 20 is obtained with the emission delay value 30 in the processing cycle #3 as a starting point. Therefore, when such emission timing is set as a starting point, the ToF value 50 and the ToF value 20 can be determined to be ghosts.

Meanwhile, for the pulse of the reflected light detected at the count code 60 in the processing cycle #2, the ToF value 140 is obtained with the emission delay value 20 in the processing cycle #1 as a starting point. Furthermore, for the pulse of the reflected light detected at the count code 50 in the processing cycle #3, the ToF value 140 is obtained with the emission delay value 10 in the processing cycle #2 as a starting point. Therefore, since a fixed ToF value can be obtained with such emission timing as a starting point, the distance measurement range time can be shifted with the emission timing at which the ToF value 140 is obtained as a starting point.

In this manner, the measurement device 11 can shift the distance measurement range time to the emission timing as the starting point of the distance measurement range time at which a fixed ToF value is obtained.

As described above, the measurement device 11 can measure the distance to the distance measurement target with high accuracy in a shorter time, as described with reference to FIGS. 4 to 12.

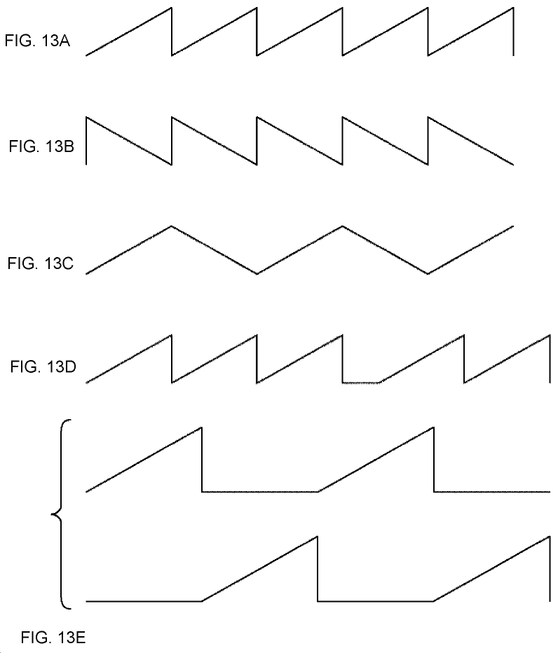

Note that, in the present embodiment, as illustrated in A of FIG. 13, the description has been given using the ramp waveform in which the counting up is repeated for each one processing cycle. However, other than this ramp waveform, a ramp waveform that circulates without stopping the counting may be used.

For example, a ramp waveform in which counting down is repeated for each one processing cycle as illustrated in B of FIG. 13, a ramp waveform in which a counting-up processing cycle and a counting-down processing cycle are alternately arranged as illustrated in C of FIG. 13, or the like can be used. Furthermore, as illustrated in D of FIG. 13, a ramp waveform in which a counting stop section exists in a certain processing cycle without stopping the counting in all the processing cycles may be used. Furthermore, a multi-slope ramp waveform (in the example illustrated in E of FIG. 13, a ramp waveform that circulates without rest by combining two waveforms) as illustrated in E of FIG. 13 may be used.

<Emission Delay Value of Predetermined Pattern>

As described above, the measurement device 11 can make the emission delay value different for each processing cycle by performing the pulse modulation, and can set the emission delay value to be random, for example. Alternatively, the measurement device 11 may set the emission delay value to be shifted in a predetermined pattern for each processing cycle.

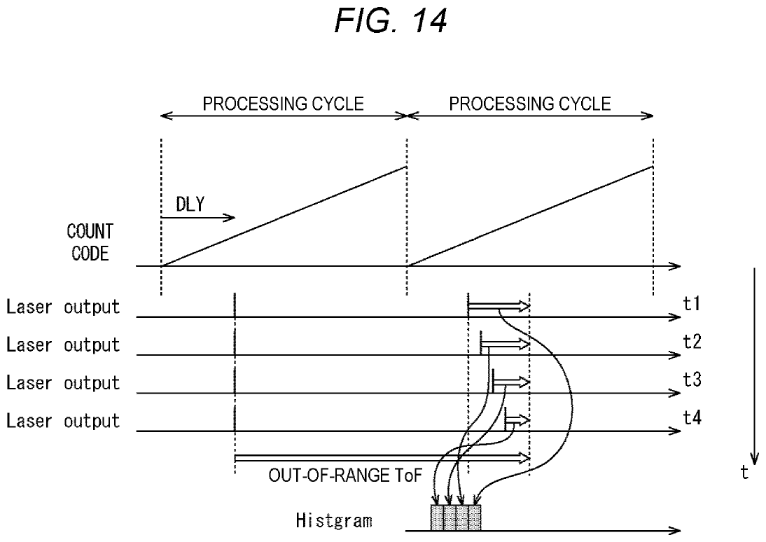

Therefore, a processing example in which the emission delay value is shifted in a predetermined pattern for each processing cycle will be described with reference to FIGS. 14 to 19.

FIG. 14 illustrates an example in which four pulses are emitted at the emission timings in which light emission timings are shifted at equal intervals (predetermined pattern) with respect to a preprocessing cycle.

As described above, by shifting the light emission timings at equal intervals, the out-of-range ToF (the ghost ToF value caused by the pulse of the reflected light detected outside the distance measurement range time) caused by light emission in the preprocessing cycle is shifted at equal intervals and integrated when the histogram is generated. Therefore, the measurement device 11 can predict the shape of the out-of-range ToF and perform filtering or the like by performing histogram processing based on the equal interval (predetermined pattern).

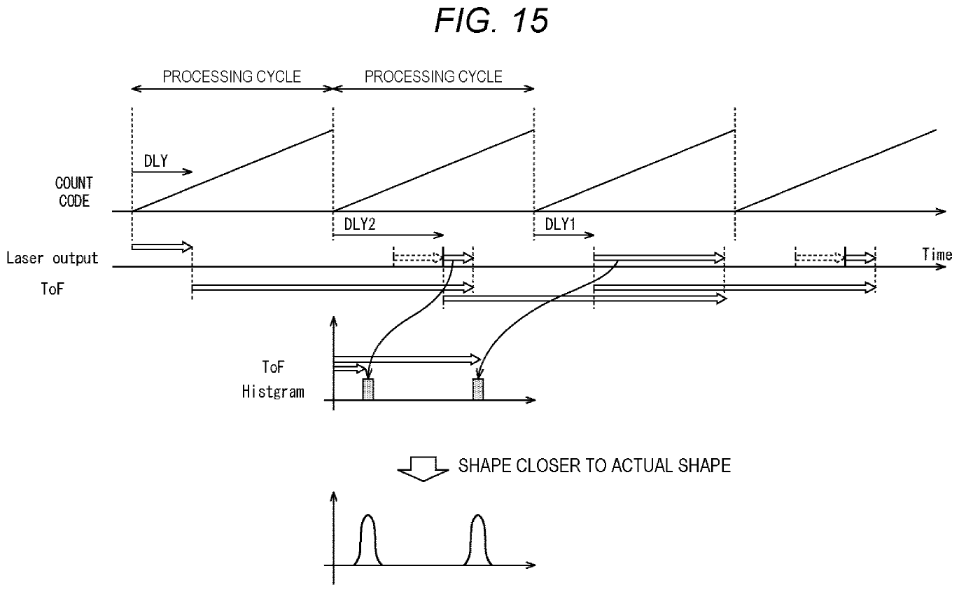

A method of controlling laser irradiation timing and a method of processing the TOF result will be described with reference to FIG. 15.

FIG. 15 illustrates an example of a pattern alternately changed by the emission delay value DLY1 and the emission delay value DLY2. That is, the timing instruction unit 16 supplies the emission delay value to the emission timing signal generation unit 12 so as to shift the light emission timing of the pulse in a pattern in which the emission delay value DLY1 and the emission delay value DLY2 are alternately arranged. Then, the calculation unit 17 performs calculation of alternately subtracting the emission delay value DLY1 and the emission delay value DLY2 supplied from the timing instruction unit 16 from the count code supplied from the latch 22 of the TDC 15, and supplies the ToF value calculated by the calculation to the histogram generation unit 18.

According to such a pattern, in the histogram generated by the histogram generation unit 18, two peaks as illustrated in the drawing occur according to the out-of-range ToF. That is, one peak occurs in the histogram shape within the range, whereas two peaks occur outside the range. Note that a histogram shape closer to an actual shape is illustrated on the lower side of FIG. 15.

Then, in the example illustrated here, the histogram generation unit 18 can predict that two peaks that are twice the emission delay value have a histogram shape due to out-of-range ToF, and can extract the histogram of the out-of-range ToF on the basis of the prediction.

Moreover, in the measurement device 11, the histogram generation unit 18 can perform calculation processing for the histogram of the out-of-range ToF. For example, the histogram generation unit 18 can perform calculation processing of separately obtaining the center of gravity of the histogram shape due to the out-of-range ToF, calculation processing of removing a portion caused by the out-of-range ToF, and calculation processing of operating the center of gravity of the histogram shape due to the out-of-range ToF (for example, an operation to move the center of gravity to non-ROI, or the like.). Of course, the histogram generation unit 18 may adopt calculation processing other than the above processing.

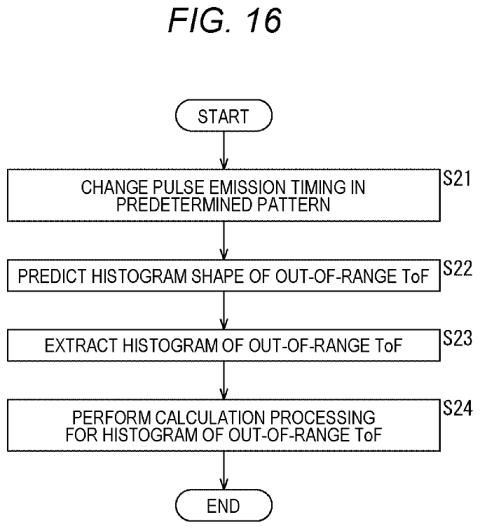

FIG. 16 is a flowchart for describing processing in which the emission delay value is shifted in a predetermined pattern for each processing cycle.

In step S21, the timing instruction unit 16 supplies the emission delay value that changes the light emission timing of the pulse in a predetermined pattern (for example, an alternate pattern as illustrated in FIG. 15) to the emission timing signal generation unit 12. As a result, the emission timing signal generation unit 12 generates the Tx pulse signal in which the emission timing delayed from the timing of starting the processing cycle is changed according to the emission delay value, and the laser driver 13 outputs the pulsed laser light according to the Tx pulse signal.

In step S22, when generating the histogram of the ToF values supplied from the calculation unit 17, the histogram generation unit 18 predicts the histogram shape of the out-of-range ToF (for example, two peaks as illustrated in FIG. 15) on the basis of a predetermined pattern in which the light emission timing of the pulse is changed.

In step S23, the histogram generation unit 18 extracts (filters) the histogram of the out-of-range ToF from the histogram shape of the out-of-range ToF predicted in step S22.

In step S24, the histogram generation unit 18 performs various types of calculation processing as described above for the histogram of the out-of-range ToF extracted in step S23, and then the processing is terminated.

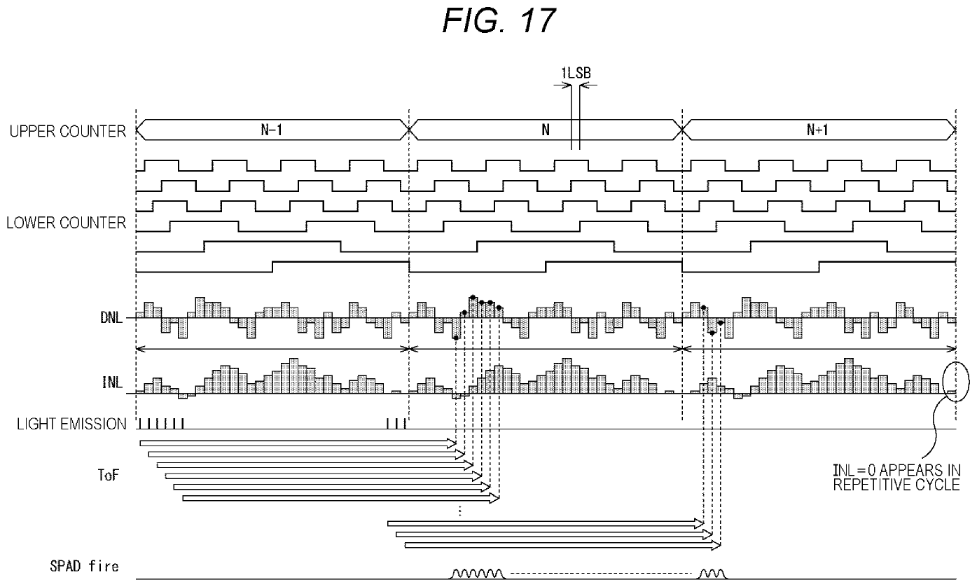

FIG. 17 is a diagram for describing the effect obtained by canceling the influence of DNL on the measurement accuracy in a case where the emission delay value is shifted in a predetermined pattern for each processing cycle, similarly to FIG. 6 described above.

As illustrated in FIG. 17, the same DNL and INL repeatedly appear, and INL=0 in the repetition cycle. Then, by performing the pulse modulation, the same ToF value is acquired from different count codes output from the TDC 15. That is, to acquire the same ToF value, the influence of the output of the TDC 15 with different DNL can be dispersed.

Note that, in FIG. 17, the time difference between edges of the counter 21 is LSB, and the time error is DNL. Furthermore, the INL is 0 in the repetition cycle (32 LSB) of the lower counter, and the DNL average of 32 ways becomes 0 according to the pulse emission timing. As described above, it is necessary to change the emission timing in order to average the DNL, and by shifting the emission delay value of the emission timing by a predetermined pattern, it is possible to prevent the shape of the ghost histogram due to the influence of the out-of-range ToF from being changed as much as possible.

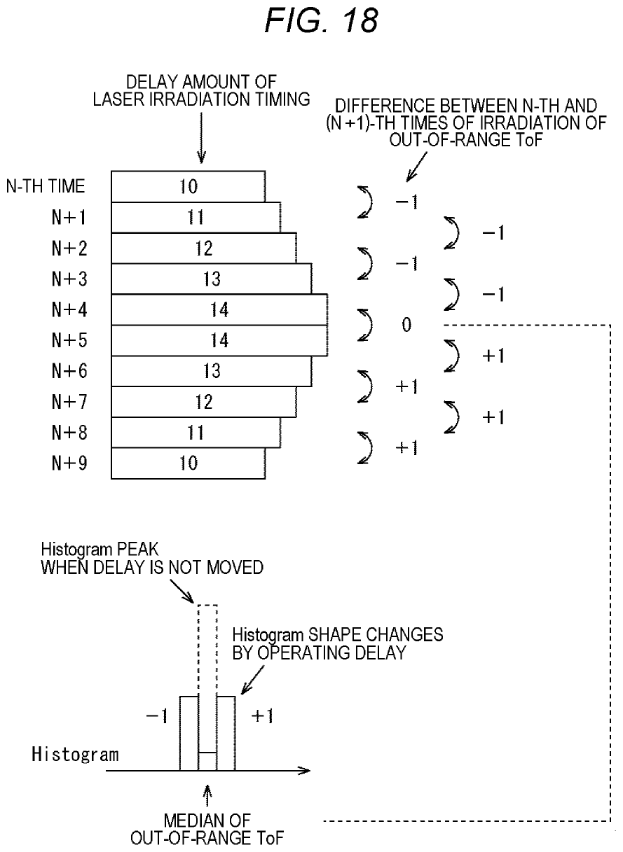

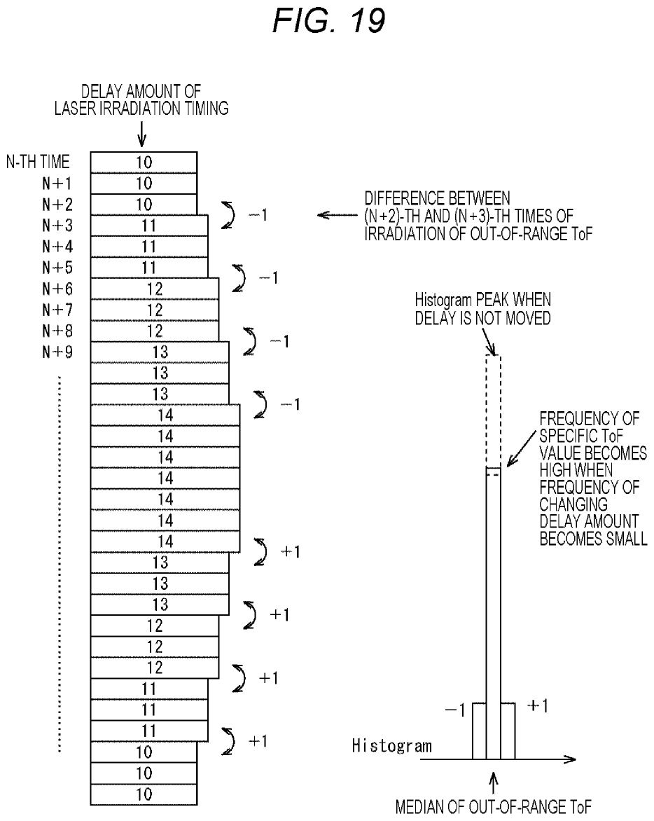

Here, the relationship between the delay of the laser irradiation timing and the DNL, and the shape of the ghost histogram due to the influence of the out-of-range ToF will be described with reference to FIGS. 18 and 19. Note that, in FIGS. 18 and 19, averaging of 5bin (averaging of 32bin in FIG. 17) is illustrated for simplification of description.

FIG. 18 illustrates a first example in which the emission delay value is shifted in such a pattern that the emission delay value increases by 1 for each one processing cycle from 10 to 14 and then decreases by 1 for each one processing cycle from 14 to 10.

In the case where the emission delay value is shifted in such a pattern, the difference between the N-th and (N+1)-th times of irradiation of the out-of-range ToF, the difference between the (N+1)-th and (N+2)-th times of irradiation of the out-of-range ToF, the difference between the (N+2)-th and (N+3)-th times of irradiation of the out-of-range ToF, and the difference between the (N+3)-th and (N+4)-th times of irradiation of the out-of-range ToF are −1. Furthermore, the difference between the (N+4)-th and (N+5)-th times of irradiation of the out-of-range ToF is 0. Moreover, the difference between the (N+5)-th and (N+6)-th times of irradiation of the out-of-range ToF, the difference between the (N+6)-th and (N+7)-th times of irradiation of the out-of-range ToF, the difference between the (N+7)-th and (N+8)-th times of irradiation of the out-of-range ToF, and the difference between the (N+8)-th and (N+9)-th times of irradiation of the out-of-range ToF are +1.

Therefore, as illustrated in the drawing, a histogram shape having two peaks of −1 and +1 and becoming low at 0 that is a median value of the out-of-range ToF is obtained. Note that in a case where the emission delay value is not changed, a histogram shape having a peak as indicated by the broken line is obtained.

FIG. 19 illustrates a second example in which the emission delay value is shifted in such a pattern that the emission delay value increases by 1 for each three processing cycles from 10 to 14 and then decreases by 1 for each three processing cycles from 14 to 10.

In the case where the emission delay value is shifted in such a pattern, the difference between the (N+2)-th and (N+3)-th times of irradiation of the out-of-range ToF, the difference between the (N+5)-th and (N+6)-th times of irradiation of the out-of-range ToF, the difference between the (N+8)-th and (N+9)-th times of irradiation of the out-of-range ToF, and the difference between the (N+11)-th and (N+12)-th times of irradiation of the out-of-range ToF are −1. Furthermore, the difference between the (N+18)-th and (N+19)-th times of irradiation of the out-of-range ToF, the difference between the (N+21)-th and (N+22)-th times of irradiation of the out-of-range ToF, the difference between the (N+24)-th and (N+25)-th times of irradiation of the out-of-range ToF, and the difference between the (N+27)-th and (N+28)-th times of irradiation of the out-of-range ToF are +1. Otherwise, the value is 0.

Therefore, as illustrated in the drawing, a histogram shape in which the frequency of the specific ToF value increases as the frequency of changing the emission delay value decreases is obtained. Note that in a case where the emission delay value is not changed, a histogram shape having a peak as indicated by the broken line is obtained. That is, it is possible to control the increase or decrease in the height of 0, which is the median value of the out-of-range ToF, by the frequency of changing the emission delay value.

By shifting the emission delay value at the emission timing in a predetermined pattern in this way, it is possible to prevent the shape of the ghost histogram due to the influence of the out-of-range ToF from being changed as much as possible. For example, in a case where the emission delay value of the emission timing is randomly shifted, such a histogram shape is not obtained because of dispersion.

<Configuration Example of Computer>

Next, the above-described series of processing (measurement method) can be executed by hardware or software. In a case of executing the series of processing by software, a program that configures the software is installed in a general-purpose computer or the like.

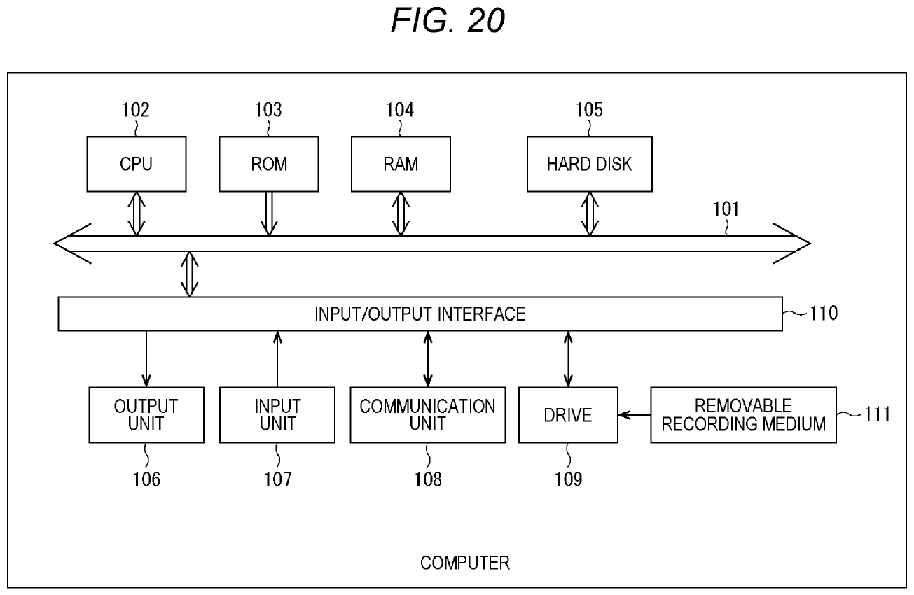

FIG. 20 is a block diagram illustrating a configuration example of an embodiment of a computer to which a program for executing the above-described series of processing is installed.

The program can be recorded in advance in a hard disk 105 or a ROM 103 as a recording medium built in the computer.

Alternatively, the program can be stored (recorded) in a removable recording medium 111 driven by a drive 109. Such a removable recording medium 111 can be provided as so-called package software. Here, examples of the removable recording medium 111 include a flexible disk, a compact disc read only memory (CD-ROM), a magneto optical (MO) disk, a digital versatile disc (DVD), a magnetic disk, a semiconductor memory, and the like.

Note that the program can be downloaded to the computer via a communication network or a broadcast network and installed in the built-in hard disk 105, in addition to the program being installed from the removable recording medium 111 to the computer, as described above. In other words, the program can be transferred in a wireless manner from a download site to the computer via an artificial satellite for digital satellite broadcasting, or transferred in a wired manner to the computer via a network such as a local area network (LAN) or the Internet, for example.

The computer incorporates a central processing unit (CPU) 102, and an input/output interface 110 is connected to the CPU 102 via a bus 101.

When a command is input through the input/output interface 110 by the user who operates an input unit 107 or the like, the CPU 102 executes the program stored in the read only memory (ROM) 103 according to the command. Alternatively, the CPU 102 loads the program stored in the hard disk 105 into a random access memory (RAM) 104 and executes the program.

As a result, the CPU 102 performs the above-described processing according to the flowchart or the above-described processing of the block diagram. Then, the CPU 102 causes an output unit 106 to output the processing result, a communication unit 108 to transmit the processing result, and the hard disk 105 to record the processing result, via the input/output interface 110, as necessary, for example.

Note that the input unit 107 is configured by a keyboard, a mouse, a microphone, and the like. Furthermore, the output unit 106 is configured by a liquid crystal display (LCD), a speaker, and the like.

Here, in the present specification, the processing performed by the computer in accordance with the program does not necessarily have to be performed in chronological order in accordance with the order described as the flowchart. In other words, the processing performed by the computer according to the program also includes processing executed in parallel or individually (for example, parallel processing or processing by an object).

Furthermore, the program may be processed by one computer (processor) or may be processed in a distributed manner by a plurality of computers. Moreover, the program may be transferred to a remote computer and executed.

Moreover, in the present specification, the term “system” means a group of a plurality of configuration elements (devices, modules (parts), and the like), and whether or not all the configuration elements are in the same housing is irrelevant. Therefore, a plurality of devices housed in separate housings and connected via a network, and one device that houses a plurality of modules in one housing are both systems.

Further, for example, the configuration described as one device (or processing unit) may be divided into and configured as a plurality of devices (or processing units). On the contrary, the configuration described as a plurality of devices (or processing units) may be collectively configured as one device (or processing unit). Furthermore, a configuration other than the above-described configuration may be added to the configuration of each device (or each processing unit). Moreover, a part of the configuration of a certain device (or processing unit) may be included in the configuration of another device (or another processing unit) as long as the configuration and operation of the system as a whole are substantially the same.

Further, for example, in the present technology, a configuration of cloud computing in which one function is shared and processed in cooperation by a plurality of devices via a network can be adopted.

Furthermore, for example, the above-described program can be executed by an arbitrary device. In that case, the device is only required to have necessary functions (functional blocks and the like) and obtain necessary information.

Further, for example, the steps described in the above-described flowcharts can be executed by one device or can be executed by a plurality of devices in a shared manner. Moreover, in the case where a plurality of processes is included in one step, the plurality of processes included in the one step can be executed by one device or can be shared and executed by a plurality of devices. In other words, the plurality of processes included in one step can be executed as processes of a plurality of steps. Conversely, the processing described as a plurality of steps can be collectively executed as one step.

Note that, in the program executed by the computer, the processing of the steps describing the program may be executed in chronological order according to the order described in the present specification, or may be individually executed in parallel or at necessary timing when a call is made, for example. That is, the processing of each step may be executed in an order different from the above-described order as long as no contradiction occurs. Moreover, the processing of the steps describing the program may be executed in parallel with the processing of another program, or may be executed in combination with the processing of another program.

Note that the plurality of present technologies described in the present specification can be implemented independently of one another as a single unit as long as there is no inconsistency. Of course, an arbitrary number of the present technologies can be implemented together. For example, part or whole of the present technology described in any of the embodiments can be implemented in combination with part or whole of the present technology described in another embodiment. Further, part or whole of the above-described arbitrary present technology can be implemented in combination with another technology not described above.

### Combination Example of Configuration

Note that the present technology can also have the following configurations.

(1)

A measurement device including:

an emission timing signal generation unit configured to generate a signal for giving an instruction on emission timing to emit a pulse of laser light repeatedly for each predetermined processing cycle;

a counter configured to continuously count a count code at a time of switching the processing cycle, the count code indicating timing at which a pulse of reflected light that is the laser light reflected by a distance measurement target and returned is received; and

a timing instruction unit configured to make an emission delay value different for the each processing cycle, the emission delay value indicating a time for delaying the emission timing from start of the processing cycle, and instruct the emission timing signal generation unit on the emission delay value.

(2)

The measurement device according to (1), further including:

a calculation unit configured to subtract the emission delay value an instruction on which is given by the timing instruction unit from the count code indicating timing at which a pulse of reflected light is received to calculate a measurement value corresponding to a value obtained by measuring a flight time in which light reciprocates between the measurement device and the distance measurement target.

(3)

The measurement device according to (2), further including:

a histogram generation unit configured to generate a histogram of the measurement value obtained by the calculation unit every time the processing cycle is repeatedly performed, and cause the processing cycle to be repeatedly performed until the measurement value indicating a peak is specified in the histogram is specified.

(4)

The measurement device according to (2), in which,

when a distance to the distance measurement target is set as a target for distance measurement, a distance measurement range time that is a width of a flight time in which light reciprocates between the measurement device and a distance measurement range representing a fixed distance width including the distance is caused to coincide with a time of the processing cycle, and the distance measurement range time is started from the emission timing delayed from start of the processing cycle.

(5)

The measurement device according to (4), in which

the emission timing signal generation unit outputs the laser light having a number of pulse emissions of two or more times within the processing cycle of one time, and

the calculation unit subtracts, for the each count code at which the pulse of the reflected light is detected, each of the emission delay values that are timings at which a plurality of the distance measurement range times including the count code is started from the count code to obtain the measurement value.

(6)

The measurement device according to any one of (1) to (5), in which

a configuration in which the count code counted by the counter is set as a lower bit and an upper bit is counted separately from counting by the counter is provided.

(7)

The measurement device according to any one of (1) to (6), in which

the timing instruction unit changes the emission timing of the pulse by the laser light over the entire processing cycle.

(8)

The measurement device according to any one of (1) to (7), in which

the counter changes a maximum value of the count code in the arbitrary processing cycle to change a length of the processing cycle.

(9)

The measurement device according to (4), in which

the distance measurement range time is shifted to the emission timing serving as a starting point of the distance measurement range time at which the fixed measurement value is obtained.

(10)

The measurement device according to (3), in which

the timing instruction unit changes the emission delay value so as to randomly change for the each processing cycle.

(11)

The measurement device according to (3), in which

the timing instruction unit changes the emission delay value so as to change in a predetermined pattern for the each processing cycle.

(12)

The measurement device according to (11), in which,

when a distance to the distance measurement target is set as a target for distance measurement, a width of a flight time in which light reciprocates between the measurement device and a distance measurement range representing a fixed distance width including the distance is set as a distance measurement range time, and

the histogram generation unit predicts a histogram shape of a ghost measurement value caused by a pulse of reflected light detected outside the distance measurement range time, and extracts the histogram shape of a ghost measurement value, on the basis of a predetermined pattern in which the emission delay value changes.

(13)

The measurement device (12), in which

the histogram generation unit performs predetermined calculation processing for the histogram shape of a ghost measurement value.

(14)

A measurement method including:

by a measurement device, generating a signal for giving an instruction on emission timing to emit a pulse of laser light repeatedly for each predetermined processing cycle;

continuously counting a count code at a time of switching the processing cycle, the count code indicating timing at which a pulse of reflected light that is the laser light reflected by a distance measurement target and returned is received; and

making an emission delay value different for the each processing cycle, the emission delay value indicating a time for delaying the emission timing from start of the processing cycle, and giving an instruction on the emission delay value.

(15)

A program for causing a computer of a measurement device to execute measurement processing including:

generating a signal for giving an instruction on emission timing to emit a pulse of laser light repeatedly for each predetermined processing cycle;

continuously counting a count code at a time of switching the processing cycle, the count code indicating timing at which a pulse of reflected light that is the laser light reflected by a distance measurement target and returned is received; and

making an emission delay value different for the each processing cycle, the emission delay value indicating a time for delaying the emission timing from start of the processing cycle, and giving an instruction on the emission delay value.

Note that the present embodiments are not limited to the above-described embodiments, and various modifications can be made without departing from the gist of the present disclosure. Furthermore, the effects described in the present specification are merely examples and are not limited, and other effects may be exhibited.

### REFERENCE SIGNS LIST

11 Measurement device
12 Emission timing signal generation unit
13 Laser driver
14 Light receiving element
15 TDC
16 Timing instruction unit
17 Calculation unit
18 Histogram generation unit
19 Distance calculation unit
21 Counter
22 Latch

1. A measurement device comprising:
an emission timing signal generation unit configured to generate a signal for giving an instruction on emission timing to emit a pulse of laser light repeatedly for each predetermined processing cycle;
a counter configured to continuously count a count code at a time of switching the processing cycle, the count code indicating timing at which a pulse of reflected light that is the laser light reflected by a distance measurement target and returned is received; and
a timing instruction unit configured to make an emission delay value different for the each processing cycle, the emission delay value indicating a time for delaying the emission timing from start of the processing cycle, and instruct the emission timing signal generation unit on the emission delay value.

2. The measurement device according to claim 1, further comprising:
a calculation unit configured to subtract the emission delay value an instruction on which is given by the timing instruction unit from the count code indicating timing at which a pulse of reflected light is received to calculate a measurement value corresponding to a value obtained by measuring a flight time in which light reciprocates between the measurement device and the distance measurement target.

3. The measurement device according to claim 2, further comprising:
a histogram generation unit configured to generate a histogram of the measurement value obtained by the calculation unit every time the processing cycle is repeatedly performed, and cause the processing cycle to be repeatedly performed until the measurement value indicating a peak is specified in the histogram is specified.

4. The measurement device according to claim 2, wherein,
when a distance to the distance measurement target is set as a target for distance measurement, a distance measurement range time that is a width of a flight time in which light reciprocates between the measurement device and a distance measurement range representing a fixed distance width including the distance is caused to coincide with a time of the processing cycle, and the distance measurement range time is started from the emission timing delayed from start of the processing cycle.

5. The measurement device according to claim 4, wherein
the emission timing signal generation unit outputs the laser light having a number of pulse emissions of two or more times within the processing cycle of one time, and
the calculation unit subtracts, for the each count code at which the pulse of the reflected light is detected, each of the emission delay values that are timings at which a plurality of the distance measurement range times including the count code is started from the count code to obtain the measurement value.

6. The measurement device according to claim 1, wherein
a configuration in which the count code counted by the counter is set as a lower bit and an upper bit is counted separately from counting by the counter is provided.

7. The measurement device according to claim 1, wherein
the timing instruction unit changes the emission timing of the pulse by the laser light over the entire processing cycle.

8. The measurement device according to claim 1, wherein
the counter changes a maximum value of the count code in the arbitrary processing cycle to change a length of the processing cycle.

9. The measurement device according to claim 4, wherein
the distance measurement range time is shifted to the emission timing serving as a starting point of the distance measurement range time at which the fixed measurement value is obtained.

10. The measurement device according to claim 3, wherein
the timing instruction unit changes the emission delay value so as to randomly change for the each processing cycle.

11. The measurement device according to claim 3, wherein
the timing instruction unit changes the emission delay value so as to change in a predetermined pattern for the each processing cycle.

12. The measurement device according to claim 11, wherein,
when a distance to the distance measurement target is set as a target for distance measurement, a width of a flight time in which light reciprocates between the measurement device and a distance measurement range representing a fixed distance width including the distance is set as a distance measurement range time, and
the histogram generation unit predicts a histogram shape of a ghost measurement value caused by a pulse of reflected light detected outside the distance measurement range time, and extracts the histogram shape of a ghost measurement value, on a basis of a predetermined pattern in which the emission delay value changes.

13. The measurement device according to claim 12, wherein
the histogram generation unit performs predetermined calculation processing for the histogram shape of a ghost measurement value.

14. A measurement method comprising:
by a measurement device,
generating a signal for giving an instruction on emission timing to emit a pulse of laser light repeatedly for each predetermined processing cycle;
continuously counting a count code at a time of switching the processing cycle, the count code indicating timing at which a pulse of reflected light that is the laser light reflected by a distance measurement target and returned is received; and
making an emission delay value different for the each processing cycle, the emission delay value indicating a time for delaying the emission timing from start of the processing cycle, and giving an instruction on the emission delay value.

15. A program for causing a computer of a measurement device to execute measurement processing comprising:
generating a signal for giving an instruction on emission timing to emit a pulse of laser light repeatedly for each predetermined processing cycle;
continuously counting a count code at a time of switching the processing cycle, the count code indicating timing at which a pulse of reflected light that is the laser light reflected by a distance measurement target and returned is received; and
making an emission delay value different for the each processing cycle, the emission delay value indicating a time for delaying the emission timing from start of the processing cycle, and giving an instruction on the emission delay value.
